(19) United States
(12) Patent Application Publication
(10) Pub. No.: US 2004/0212816 A1
(43) Pub. Date: Oct. 28, 2004

(54) Sheet for color calibration, color calibrating method, and image recording apparatus

(75) Inventors: Tsuyoshi Tanabe, Kanagawa (JP); Naoyuki Morita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/827,346

(22) Filed: Apr. 20, 2004

(30) Foreign Application Priority Data
Apr. 25, 2003 (JP) 2003-121921

(51) Int. Cl. H04N 1/48; H04N 1/50

(52) U.S. Cl. 358/1.9; 358/504; 283/117

(57) ABSTRACT

A sheet for color calibration, comprising: an output medium information patch which displays output medium information; a test pattern for color calibration; and at least one of a first reference patch which displays color information serving as a reference for color correction when the output medium information patch is read, and a second reference patch serving as a reference for correcting a feed length when the sheet for color calibration is read.

### CROSS-REFERENCE TO RELATED APPLICATION

This application claims priority under 35USC 119 from Japanese Patent Application No. 2003-121921, the disclosure of which is incorporated by reference herein.

### BACKGROUND OF THE INVENTION

1. Field of the Invention

The present invention relates to a sheet for color calibration, a color calibrating method, and an image recording apparatus. More particularly, the invention relates to: a sheet for color calibration in which much more output medium information can be contained as compared with a conventional sheet for color calibration, and virtually no misreading of output medium information occurs; a color calibrating method using the sheet for color calibration; and an image recording apparatus for producing the sheet for color calibration to carry out color calibration.

2. Description of the Related Art

A fully automatic exposure and developing apparatus has been proposed for exposing, developing, drying, and cutting rolled printing paper in a fully automatic mode to produce a print of a predetermined size, having functions of: producing on the printing paper a patch sheet for color calibration having recorded therein output medium information such as a type of printing paper or an ID of a magazine for mounting printing paper together with a specific test pattern for color calibration; reading the produced patch sheet; and checking whether or not printing paper targeted for color calibration is correct and whether or not a magazine with a correct ID is mounted (Japanese Patent Application Laid-open (JP-A) No. 2000-241893).

However, in JP-A No. 2000-241893, it is abstractly described that a mode of the output medium information patch “may be recorded by any method such as printing, bar code reading, color setting, or recording position setting”, and there is no clear disclosure of a specific mode.

It is considered that, in addition to white or black, as a color of a zone configuring an output medium information patch (hereinafter, referred to as a “patch”), a type or quantity of output medium information which can be contained in a patch can be significantly increased by using cyan, magenta, and yellow, or alternatively, a chromatic color such as a mixed color of cyan, magenta, and yellow.

However, in a case where a sheet for color calibration is produced immediately after a magazine has been replaced with a replacement magazine in an automatic exposure and developing apparatus, this tends to produce a sheet for color calibration with greatly displaced hue. Therefore, if an output medium information patch is merely formed in combination of regions having a variety of chromatic colors, there is a possibility that output medium information recorded as color information is misread or cannot be read.

### SUMMARY OF THE INVENTION

The present invention has been made in order to solve the foregoing problem. It is an object of the invention to provide a sheet for color calibration in which much more output medium information can be contained as compared with a conventional sheet for color calibration, and virtually no misreading of output medium information occurs; a color calibrating method using the sheet for color calibration; and an image recording apparatus for producing the sheet for color calibration to carry out color calibration.

According to a first aspect of the invention, there is provided a sheet for color calibration, comprising:

(a) an output medium information patch which displays output medium information;

(b) a test pattern for color calibration; and

(c) at least one of a first reference patch which displays color information serving as a reference for color correction when the output medium information patch is read, and a second reference patch serving as a reference for correcting a feed length when the sheet for color calibration is read.

According to a second aspect of the invention, there is provided a sheet for color calibration according to the first aspect, wherein the output medium information patch and the test pattern for color calibration are formed by exposing a photosensitive material with a predetermined amount of light exposure.

According to a third aspect of the invention, there is provided a sheet for color calibration according to the first aspect, wherein the first reference patch and the second reference patch are formed by exposing a photosensitive material with a predetermined amount of light exposure.

On a sheet for color calibration, in a case where an output medium information patch is configured in combination of a patch of cyan, magenta, and yellow or a chromatic color such as a mixed color of cyan, magenta, and yellow other than a patch of achromatic colors such as white, gray, and black, misreading caused by a hue shift may occur.

However, on a sheet for color calibration, a first reference patch is formed by exposing a photosensitive material with a predetermined amount of light exposure. Thus, when an image tends to form with greatly displaced hue, for example, immediately after a magazine has been replaced with a replacement magazine, a hue shift appears in the first reference patch. Therefore, color correction information serving as a reference when color correction for correcting a hue shift can be obtained by reading the reference patch.

Therefore, misreading of an output medium information patch caused by a hue shift can be effectively prevented by correcting a read result of an output medium information patch based on color information.

Hence, in addition to a patch of achromatic color, an output medium information patch can be configured by combining a patch of chromatic color, and thus, much more output medium information can be displayed by a fewer number of patches. The patch used here denotes a small region having any of the colors, and is generally formed in a rectangular shape.

Output medium information patches include: an output medium information patch described later, the patch being displayed in combination of any one of white, black, cyan, magenta, yellow, and a mixed color of cyan, magenta, and yellow; and an output medium information patch or the like described later, the patch being displayed in combination of any one of white, black, cyan, magenta, and a mixed color of cyan and magenta.

Output medium information which can be displayed in an output medium information patch includes, for example, a type or sensitivity of a photosensitive material for producing a sheet for color calibration, a coloring feature, a width, a length, and an ID of a magazine on which a photosensitive material has been mounted.

A mode of an output medium information patch includes two or three patches of each color arranged along a reading direction of a sheet for color calibration. The number of patches can be properly determined depending on an amount of output medium information to be displayed on an output medium information patch.

In a case where a length along the reading direction of a test pattern for color calibration formed on a sheet for color calibration is short or in a case where reading is carried out while a sheet for color calibration is reciprocated many times, a feed error of a sheet for color calibration is accumulated while the test pattern for color calibration is read at a reading portion, and a read error due to a position shift may occur.

However, on the sheet for color calibration, since the second reference patch is also read together with the test pattern for color calibration and output medium information patch, feed length information indicated in the second reference patch is also retrieved by an image recording apparatus. Therefore, a feed quantity of the sheet for color calibration is corrected based on the feed length information retrieved by the image recording apparatus, whereby accumulation of the feed error is prevented, and thus, an occurrence of a read error due to a position shift is effectively prevented.

In a case where the first reference patch and the second reference patch are formed, misreading of an output medium information patch caused by a hue shift and a position shift can be effectively prevented.

According to a fourth aspect of the invention, there is provided a sheet for color calibration according to the first aspect, wherein the first reference patch and the second reference patch are arranged substantially in a single column.

On the sheet for color calibration, color information and feed length information can be read by merely feeding the sheet for color calibration along the reading direction once. Therefore, in an image forming apparatus such as an automatic exposure and developing apparatus described in the Description of the Related Art section, a feed operation can be simplified when the sheet for color calibration is read while it is fed.

According to a fifth aspect of the invention, there is provided a sheet for color calibration according to the first aspect, wherein the test pattern is formed on a color-by-color basis of cyan, magenta, and yellow, and includes a plurality of density regions arranged column-wise in order of color brightness or in order of color darkness along a reading direction of the calibration sheet.

On the sheet for color calibration, the test pattern for color calibration is an array of three colors of cyan, magenta, and yellow serving as a basis of a color photograph. Thus, in the image recording apparatus, it is easy to visually recognize which of the three colors has weak coloring as well as reading at a reading portion of the image forming apparatus.

According to a sixth aspect of the invention, there is provided a sheet for color calibration according to the first aspect, wherein the test pattern has a mixed color of cyan, magenta, and yellow, and includes a plurality of density regions arranged column-wise in order of color brightness or in order of color darkness along a reading direction of the calibration sheet.

At a reading portion described later which the image recording apparatus comprises, when a test pattern for color calibration of the sheet for color calibration is read, it is sufficient that the sheet for color calibration is fed once along the reading direction. There is no need to move the sheet for color calibration in a direction orthogonal to the reading direction. Therefore, a configuration and operation of the reading portion in the image recording apparatus can be simplified.

According to a seventh aspect of the invention, there is provided a sheet for color calibration according to the sixth aspect, wherein the test pattern and the output medium information patch are arranged substantially in a single column.

On a sheet for color calibration, reading between a test pattern for color calibration and output medium information can be carried out by merely moving the sheet along the reading direction.

According to an eighth aspect of the invention, there is provided a sheet for color calibration according to the sixth aspect, wherein the test pattern, the output medium information patch, the first reference patch, and the second reference patch are arranged substantially in a single column.

On a sheet for color calibration, reading of a test pattern for color calibration, color correction of output medium information, feed length correction, and reading thereof can all be carried out by merely moving the sheet along the reading direction. Therefore, a configuration and operation of the reading portion can be further simplified.

According to a ninth aspect of the invention, there is provided a sheet for color calibration according to the first aspect, wherein the output medium information patch includes a combination of patches having any one of white, black, cyan, magenta, and a mixed color of cyan and magenta.

On a sheet for color calibration, as described previously, an output medium information patch is displayed in combination of one or more patches having any of the five colors of white, black, cyan, magenta, and a mixed color of cyan and magenta. Thus, much more output medium information can be displayed as compared with a case in which output medium information is displayed in a region of two colors, black and white. In addition, in an output medium information patch, if developing, fixing, and color processing are carried out by a degraded developer or a developer containing yellow in which coloring is comparatively weak and in which density is likely to change, a so-called “Y stain” effect occurs whereby a photosensitive material after development becomes entirely or partially yellow. However, by using a fixing or coloring liquid of black, cyan, and magenta, whose coloring is clear, the Y stain effect hardly occurs. Therefore, on a sheet for color calibration produced under a condition in which the Y stain easily occurs as well, misreading of the output medium information due to yellowing of the output medium information patch does not occur.

According to a tenth aspect of the invention, there is provided a color calibrating method when an image is recorded on a sheet for color calibration which includes:

an output medium information patch which displays output medium information;

a test pattern for color calibration; and

at least one of a first reference patch which displays color information serving as a reference for color correction when the output medium information patch is read, and a second reference patch serving as a reference for correcting a feed length when the sheet for color calibration is read, the method comprising:

feeding in one direction or reading in a reciprocate manner the sheet for color calibration along a direction of forming the test pattern and the output medium information patch; and

calibrating a color of an image based on the read test pattern information and output medium information.

In this color calibrating method, a hue of an image formed on the photosensitive material is calibrated based on the test pattern for color calibration and output medium information obtained by reading a sheet for color calibration on which at least one of the first reference patch serving as a reference for color correction and the second reference patch serving as a reference for position correction is formed.

Therefore, in a case where a hue shift or position shift occurs on a sheet for color calibration, the hue shift or position shift can be corrected based on color information obtained by reading the first reference patch and feed length information obtained by reading the second reference patch. Therefore, a correct test pattern for color calibration and output medium information can be obtained even from the sheet for color calibration. Thus, in an automatic exposure and developing apparatus, an image without a hue shift can be produced even under a condition in which a hue shift is likely to occur, for example, immediately after a magazine has been replaced with a replacement magazine.

According to an eleventh aspect of the invention, there is provided an image recording apparatus comprising:

(A) a color calibration sheet forming portion which forms a sheet for color calibration including an output medium information patch which displays output medium information, a test pattern for color calibration, and at least one of a first reference patch which displays color information serving as a reference for color correction when the output medium information patch is read, and a second reference patch serving as a reference for correcting a feed length when the sheet for color calibration is read;

(B) a reading portion which reads the sheet for color calibration; and

(C) a calibration control portion which carries out calibration of a color of an image according to the reading result.

In this image recording apparatus, at the color calibration sheet producing portion, the output medium patch, the test pattern for color calibration, and at least one of the first reference patch, and the second reference patch are recorded in a photosensitive material, and a sheet for color calibration sheet is produced.

The sheet for color calibration produced at the color calibration sheet producing portion is read at the reading portion. The read result is corrected based on at least one of color information recorded in the first reference patch, the color information being read together with the output medium patch and the test pattern for color calibration and feed length information recorded in the second reference patch. Then, the output medium information and the test pattern for color calibration are read.

Then, a type of a photosensitive material and a magazine on which the photosensitive material is mounted are determined based on the read output medium information.

At the calibration control portion, based on the output medium information read at the reading portion, a test pattern for color calibration corresponding to the photosensitive material is retrieved from the read test pattern for color calibration. Then, a color of an image to be recorded on the photosensitive material is corrected based on the test pattern for color calibration.

In a color calibrating method, as described previously, a sheet for color calibration on which at least one of the first reference patch and second reference patch is formed is read; a test pattern for color calibration and output medium information are corrected; and a color of an image formed on a photosensitive material is corrected based on the corrected test pattern for color calibration and output medium information.

Therefore, in a case where a hue shift or position shift occurs on a sheet for color calibration as well, a correct test pattern for color calibration and output medium information can be read. Thus, an image without a hue shift can be formed even under a condition in which a hue shift is likely to occur.

Further, in a case where a first reference patch is formed on a sheet for color calibration, as described previously, color correction is applied even when a hue shift occurs with an output medium information patch, whereby the correct output medium information can be read. Thus, a variety of chromatic colors can be used for an output medium information patch in addition to an achromatic color. Therefore, if the number of patches is identical, much more output medium information can be contained. Thus, at the calibration control portion, a color of an image recorded by the image recording medium can be corrected with further fineness.

According to a twelfth aspect of the invention, there is provided an image recording apparatus according to the eleventh aspect, wherein the calibration control portion comprises:

a storage portion which stores reference output information in advance;

a checking portion which checks the reference output medium information with output medium information obtained by reading of the sheet for color calibration; and

a selecting portion which selects a test pattern for color calibration to be used for calibration from among test patterns for color calibration obtained by the reading according to the checked result.

In this image recording apparatus as well, similarly, a sheet for color calibration is produced at the color calibration sheet producing portion, and the output medium information and test pattern for color calibration recorded on the sheet for color calibration are read at the reading portion.

The output medium information read at the reading portion is compared and checked with output medium information concerning a photosensitive material targeted for actually recording an image and a magazine on which the photosensitive material is mounted at the checking portion.

At the checking portion, when it is determined that the output medium information read at the reading portion corresponds with the output medium information concerning a photosensitive material targeted for actually recording an image and a magazine on which the photosensitive material is mounted, the calibration control portion selects the test pattern for color calibration read at the reading portion as a test pattern for color calibration to be used for calibration, and carries out correction of a color of an image based on the selection.

On the other hand, at the checking portion, in a case where it is determined that the output medium information read at the reading portion is different from the output medium information concerning a photosensitive material targeted for actually recording an image, the calibration control portion may carry out correction of a color of an image based on the determination result by retrieving a test pattern for color calibration which corresponds to the latter output medium information. In addition, an image may be recorded without carrying out calibration of a color itself.

In this manner, since the checking portion carries out checking of output medium information, calibration of a color can be carried out based on a test pattern for color calibration which corresponds to a photosensitive material targeted for actually recording an image. Thus, occurrence of an accident in which an image with a large hue shift is formed can be effectively prevented.

### BRIEF DESCRIPTION OF THE DRAWINGS

FIG. 1 is a block diagram depicting a configuration of a digital laboratory system according to one embodiment of the present invention.

FIG. 2 is a block diagram depicting a configuration of a main controller.

FIG. 3 is a plan view showing a first example of a patch sheet.

FIG. 4 is a plan view showing a second example of a patch sheet.

FIG. 5 is a plan view showing a third example of a patch sheet.

FIG. 6 is a plan view showing a fourth example of a patch sheet.

FIG. 7 is a flow chart showing procedures for reading the patch sheets shown in FIGS. 3 to 6, and calibrating an exposure portion based on a result of the reading.

FIG. 8 is a flow chart showing details on procedures for producing a patch sheet.

FIG. 9 is a flow chart showing procedures for updating a lookup table.

FIG. 10 is a flow chart showing other procedures for updating a lookup table.

### DETAILED DESCRIPTION OF THE INVENTION

Hereinafter, a digital laboratory system (image recording apparatus) according to preferred embodiments of the present invention will be described with reference to the accompanying drawings.

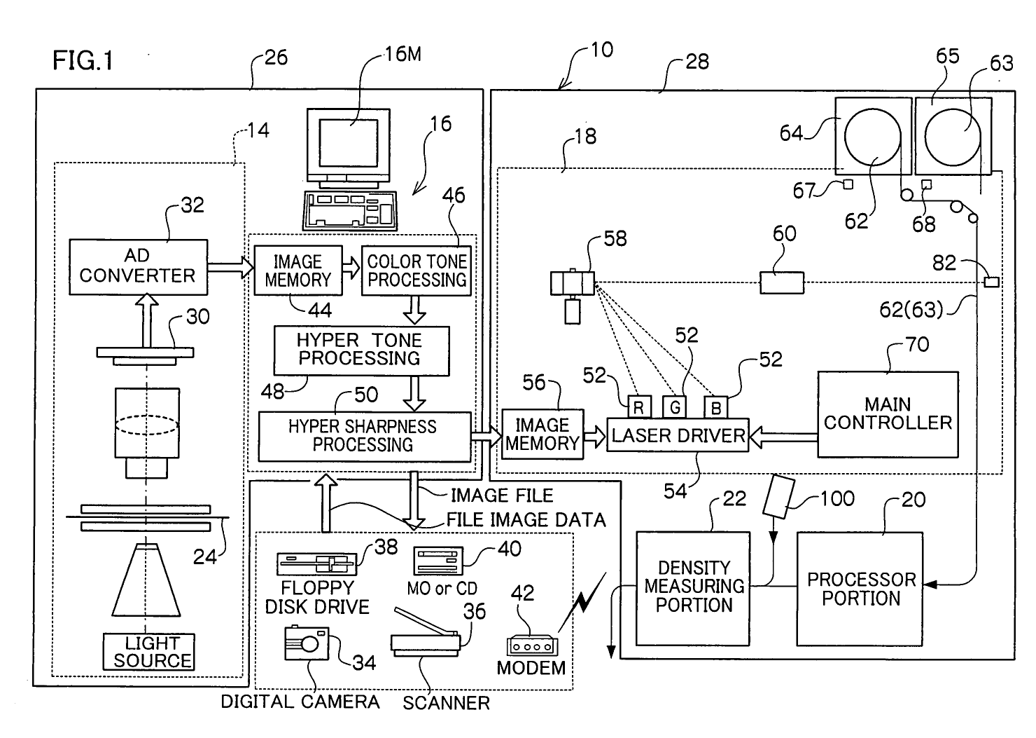

As shown in FIG. 1, a digital laboratory system 10 includes: a line CCD scanner 14; an image processing portion 16; an exposure portion 18; a developing portion 20; and a patch sheet reading portion 22. The line CCD scanner 14 and image processing portion 16 are integrated with each other as an input portion 26. The exposure portion 18, the developing portion 20, and the patch sheet reading portion 22 are integrated with each other as an output portion 28.

The line CCD scanner 14 is provided to read a frame image recorded in a photography film 24 such as a negative film or a reversal film. For example, this scanner can read frame images of a photography film of size 135; a photography film of size 110; a photography film on which a transparent magnetic layer is formed (photography film of size 240: so-called “APS film”), and photography films of size 120 and size 220 (Brownie size). The line CCD scanner 14 reads a frame image targeted for reading by a line CCD 30, A/D converts the read frame image by an A/D converting portion 32, and then, outputs image data to the image processing portion 16. In the present embodiment, a case of reading the photography film 24 of size 135 will be described by way of example.

Image data (scanned image data) outputted from the line CCD scanner 14 is inputted to the image processing portion 16. In addition, a configuration is provided so as to enable external inputs of: image data obtained by photographing by a digital camera 34 or the like; image data obtained by reading a manuscript (such as a reflection copy, for example) by a scanner 36; image data generated by another computer and recorded in a floppy disk drive 38 or an MO drive or CD drive 40; and communication image data or the like received via a modem 42 (hereinafter, these data are referred to as.“file image data”).

The image processing portion 16 has: an image memory 44 which records inputted image data; a color tone processing portion 46 which corrects a color tone by reading out the image data from the image memory 44; a hyper tone processing portion 48 which carries out hyper tone processing with respect to the image data whose color tone has been corrected; and a hyper sharpness processing portion 50 which carries out hyper sharpness processing with respect to the image data to which hyper tone processing has been applied. At the image processing portion 16, image data subjected to a variety of image processings is outputted as recording image data to the exposure portion 18. In addition, the image processing portion 16 can make external outputs such as outputting the image data subjected to image processing as an image file to a storage medium such as an FD, an MO, or a CD, and transmission to another information processing device via a communication line.

Two types of printing papers 62 and 63 are mounted on the exposure portion 18. The printing papers 62 and 63 are mounted in a state in which they are wound in a roll around respective magazines 64 and 65. Signs or the like (not shown) for specifying the printing paper type are provided to the magazine 64 and magazine 65, respectively. An identification sensor 67 and an identification sensor 68 for reading the signs or the like are provided at a magazine 64 mounting portion and a magazine 65 mounting portion of the exposure portion 18.

The exposure portion 18 further includes: an image memory 56 connected to the image processing portion 16; a laser driver 54 connected to the image memory 56; a laser light source 52 controlled by the laser driver 54; and a polygon mirror 58 and an fθ lens 60 for operating a laser light beam emitted from the laser light source 52.

The recording image data inputted from the image processing portion 16 is temporarily stored in the image memory 56, and the temporarily stored image data is inputted to the laser driver 54. The laser driver 54 controls the laser light source 52 based on the inputted recording image data, and modulates laser light beams of three colors of R (red), G (green), and B (blue) emitted from the laser light source 52. The laser light beams emitted from the laser light source 52 are scanned on the printing paper 62 (or 63) by means of the polygon mirror 58 and the fθ lens 60, and a latent image is formed on the printing paper 62 (or 63) by means of scanning and exposure.

The printing paper 62 (or 63) on which such a latent image has been formed is then transferred to the developing portion 20, and each of processings such as coloring development, whitening fixing, washing with water, and drying is applied to the transferred paper. In this manner, the latent image formed on the printing paper 62 (or 63) is substantively produced, and a positive image is formed.

The image-formed printing paper 62 (or 63) is transferred to the patch sheet reading portion 22. In a case where execution of calibration is instructed, the patch sheet reading portion 22 measures a density of printing paper on which a test pattern for calibration has been recorded, i.e., a density of a patch sheet 100 (described later), and reads information indicated on the patch sheet 100. The patch sheet 100 is provided as an example of the sheet for color calibration according to the present invention. In a case where execution of calibration is not instructed, the image-formed printing paper 62 (or 63) is ejected without undergoing density measurement. In addition, an already produced patch sheet 100 can be inserted into this patch sheet reading portion 22.

A temperature sensor 82 is arranged in the vicinity of a position on the printing paper 62 (or 63) at which the laser light beam is emitted. The temperature sensor 82 senses environment information such as a temperature which greatly influences exposure quantity—coloring density characteristics.

The temperature sensed by the temperature sensor 82 may be a temperature of printing paper or may be an atmospheric temperature. In addition, for sensing environment information other than a temperature, for example, a humidity, a humidity meter may be arranged in the vicinity of the temperature sensor 82.

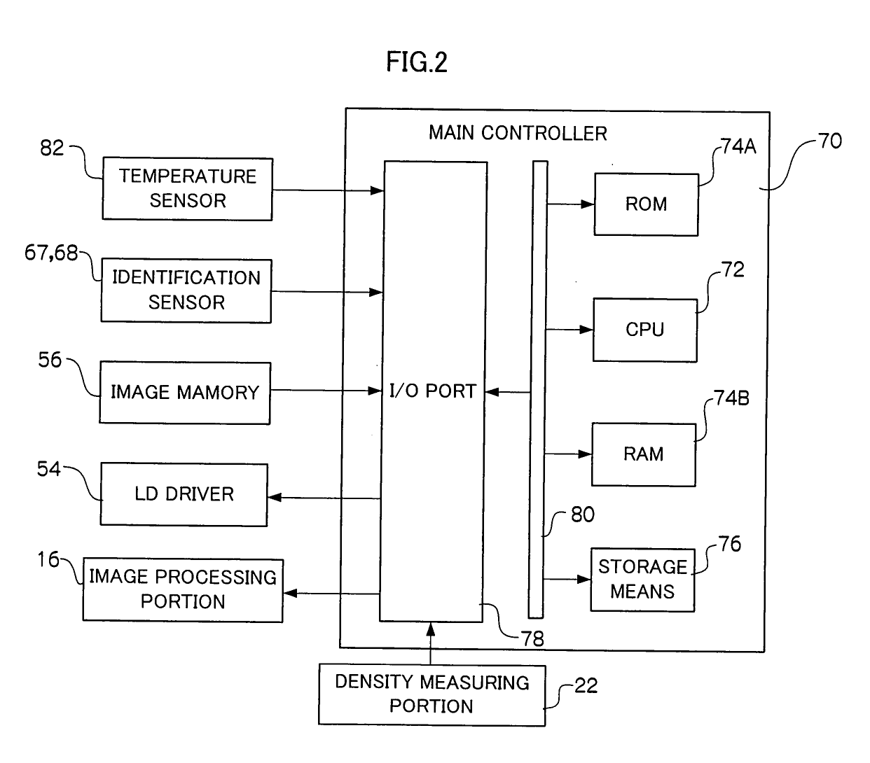

Further, the exposure portion 18 includes a main controller 70 which controls the exposure portion 18. FIG. 2 shows a schematic configuration of the main controller 70.

As shown in FIG. 2, the main controller 70 has: a CPU 72; a ROM 74A; a RAM 74B; a rewritable nonvolatile memory 76; and an input/output port 78. The CPU 72, RAM 74A, RAM 74B, storage means 76, and input/output port 78 are connected to one another via a bus 80.

The image memory 56, identification sensors 67 and 68, and temperature sensor 82 are connected to an input side of the input/output port 78. Therefore, a reading result such as recording image data or a sign for identifying the printing paper type provided to a magazine, and a temperature measurement result are inputted to the main controller 70. Furthermore, the patch sheet reading portion 22 is also connected to the input side of the input/output port 78, and a reading result of the patch sheet 100 by the patch sheet reading portion 22 is also inputted to the input/output port 78.

The laser driver 54 and image processing portion 16 are connected to an output side of the input/output port 78. Therefore, the main controller 70 can drive the laser light source 52 via the laser driver 54 or can display a message or the like on a display 16M provided at the image processing portion 16 as required.

The storage means 76 stores: output medium information such as a magazine ID, a width of set printing paper, and a type of a photosensitive emulsion; a lookup table indicating an exposure quantity relevant to a target density value as a reference for converting image data to an exposure signal; and an output history of a test pattern for color calibration. Therefore, a lookup table corresponding to each of the printing papers 62 and 63 set at the respective magazines 64 and 65 can be selected from the storage means 76, and a date and time when the latest test pattern for calibration has been outputted can be checked. For example, a magazine ID of the magazine 64 is set to 1, and a magazine ID of the magazine 65 is set to 2, respectively.

In the main controller 70, when an instruction for recording image or the like is inputted to the printing paper 62 (or 63) set at the magazine 64 (or 65), a sign or the like described at the magazine 64 (or 65) is read, and the printing paper type of the printing paper 62 (or 63) is identified. Then, a lookup table corresponding to the identified printing paper type is selected from among the lookup tables stored in the storage means 76. By using the selected lookup table, recording image data is converted into an exposure signal by means of the CPU 72. Then, an LD 52 is driven via the laser driver 54 in accordance with the exposure signal, and a laser light beam is emitted to the printing paper 62 (or 63).

In addition, when replacement of a magazine set at the exposure portion 18 is sensed as a result of sensing by the identification sensors 67 and 68, the main controller 70 causes the display 16M to display a message prompting to judge whether or not calibration is to be carried out.

The ROM 74A stores test pattern data for calibration (image data) in advance. When execution of calibration is instructed, this test pattern data for calibration is converted into an exposure signal by using the lookup table corresponding to the magazine targeted for calibration. Then, the test pattern for calibration is recorded on printing paper, and a patch sheet 100 is produced.

At this time, together with the test pattern for calibration, the main controller 70 records in the patch sheet 100 the magazine ID or output medium information concerning printing paper mounted on the magazine. Further, a date and time during output of the test pattern for calibration and output condition information 105 concerning a temperature or the like measured by the temperature sensor 82 may also be recorded in the patch sheet 100. The date and time during output of the test pattern for calibration which is one of the items of the output condition information 105 are updated and stored in output history information contained in the storage means 76.

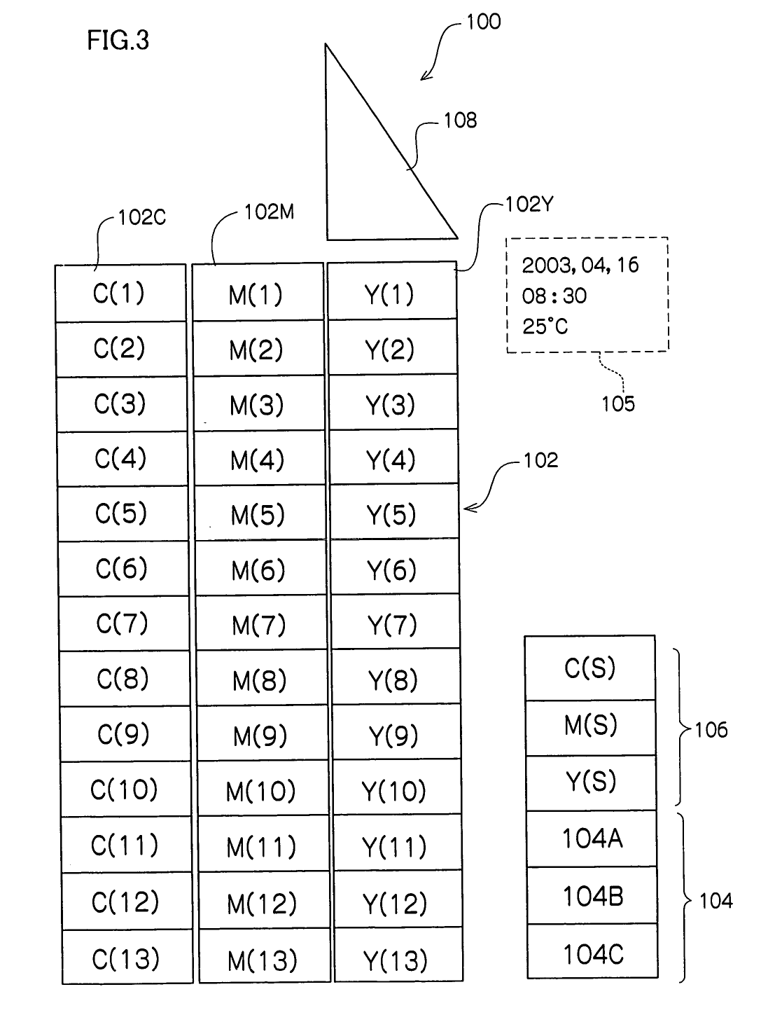

FIGS. 3 to 6 each show an example of the patch sheet 100 produced by the exposure portion 18. The patch sheet 100 is provided as an example of the sheet for color calibration according to the invention.

The patch sheet 100 shown in FIG. 3 forms: a calibration test pattern 102 which consists of density region columns 102C, 102M, and 102Y produced for each of the colors, cyan (C), magenta (M), and yellow (Y); an output medium information patch 104 which consists of three regions 104A, 104B, and 104C formed adjacent to the lower right of the test pattern and having output medium information recorded therein; and a color correction patch 106 which is contiguously displayed upwardly of the output medium information patch 104 and formed by exposing the printing paper 62 (or 63) under a predetermined condition, the color correction patch consisting of regions of three colors, cyan, magenta, and yellow. Output condition information is indicated in a region at the right of the calibration test pattern 102, the region being indicated at an upper side 105 of the output medium information patch 104. The calibration test pattern 102, output medium information patch 104, and color correction patch 106 correspond to a test pattern for color calibration, an output medium information patch, and a first reference patch, respectively, according to the invention. A triangular insertion direction display region 108 indicating an insertion direction when the patch sheet 100 is inserted into the patch sheet reading portion 22, and a reading direction at the patch sheet reading portion 22 are formed upwardly of the density region column 102Y.

The density region columns 102C, 102M, and 102Y in the calibration test pattern 102 consist of 13 density regions C(1) to C(13), density regions M(1) to M(13), and density regions Y(1) to Y(13) which are cyan, magenta, and yellow, and which have different densities, respectively. The density regions C(1) to C(13) are arranged in order of density from the density region C(1) whose density is the highest, to the density C(13) whose density is the lowest. This applies to the density regions M(1) to M(13) and the density regions Y(1) to Y(13) as well.

The output medium information patch 104 consists of the three regions 104A, 104B, and 104C each displayed by any of white, black, cyan, magenta, yellow, and a mixed color of cyan, magenta, and yellow. Output medium in formation is recorded in the region 104A, the region 104B, and the region 104C.

The color correction patch 106 is formed by exposing the printing paper 62 (or 63) at a predetermined density. As described previously, three regions, i.e., a region C(S) which is a region of cyan; a region M(S) which is a region of magenta; and a region Y(S) which is a region of yellow are vertically arranged, and are provided as a reference for color correction when the output medium information patch 104 is read. The phrase “exposure at a predetermined density” used here denotes that exposure is carried out so as to be at a density identical to that of the region in a case where any region of the output medium information patch 104 is expressed by cyan, magenta, or yellow. The color correction patch 106 is set at the same density as that of the region of the output medium information patch 104, whereby precise color correction can be carried out even under a condition in which a variance in color density at an initial stage of color correction is large.

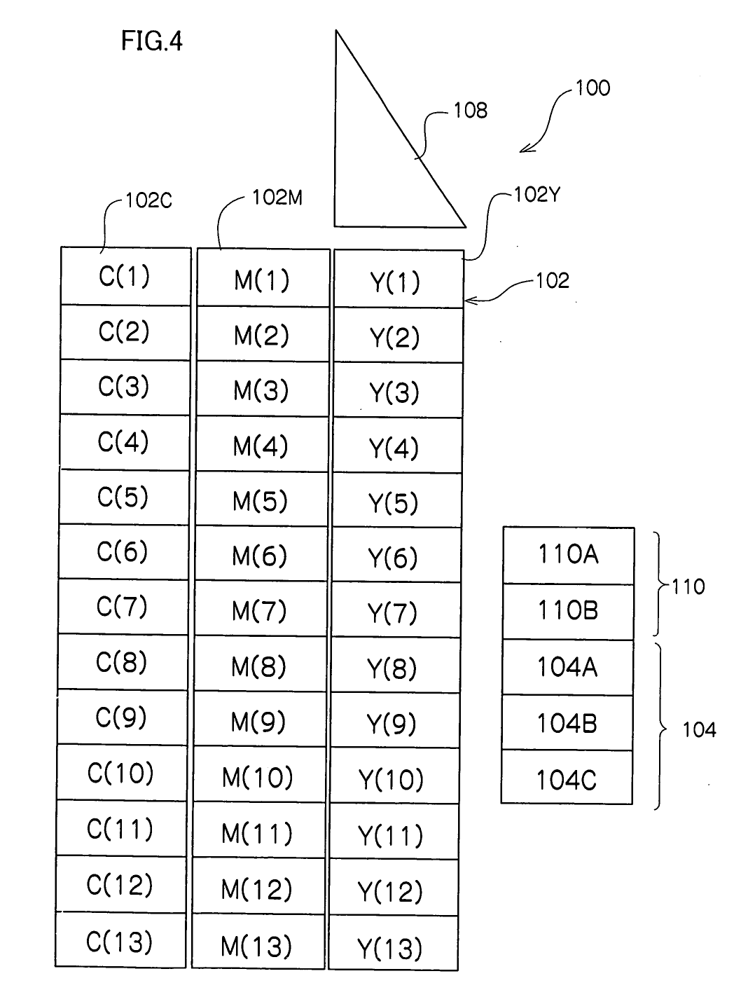

The patch sheet 100 shown in FIG. 4 is provided as an example in which a feed quantity correction patch 110 has been formed instead of the color correction patch 106 in the patch sheet 100 shown in FIG. 3. The feed quantity correction patch 110 is provided as a patch for displaying feed length information which serves as a reference for correcting a feed length when the patch sheet 100 is fed at the patch sheet reading portion 22. This patch is also provided as an example of a second reference patch on the sheet for color calibration according to the invention. It is preferred that the feed quantity correction patch 110 be configured such that a density difference from a peripheral region which is a peripheral region of the feed quantity patch 116 is clarified so that a patch feed length can be measured with high precision. For example, this correction patch can be composed of a black region 110A and a white region 110B. By configuring the feed quantity correction patch 110 in this way, the patch sheet reading portion 22 is read in order of the peripheral region (white)→the black region 110A→the white region 110B, whereby a length in the feeding direction of the black region 110A can be provided as a reference for feed quantity correction. In addition, any of the black region 110A and white region 110B can be formed so as to be equal to a length along the feeding direction of each of the regions of the density region columns 102C, 102M, and 102Y.

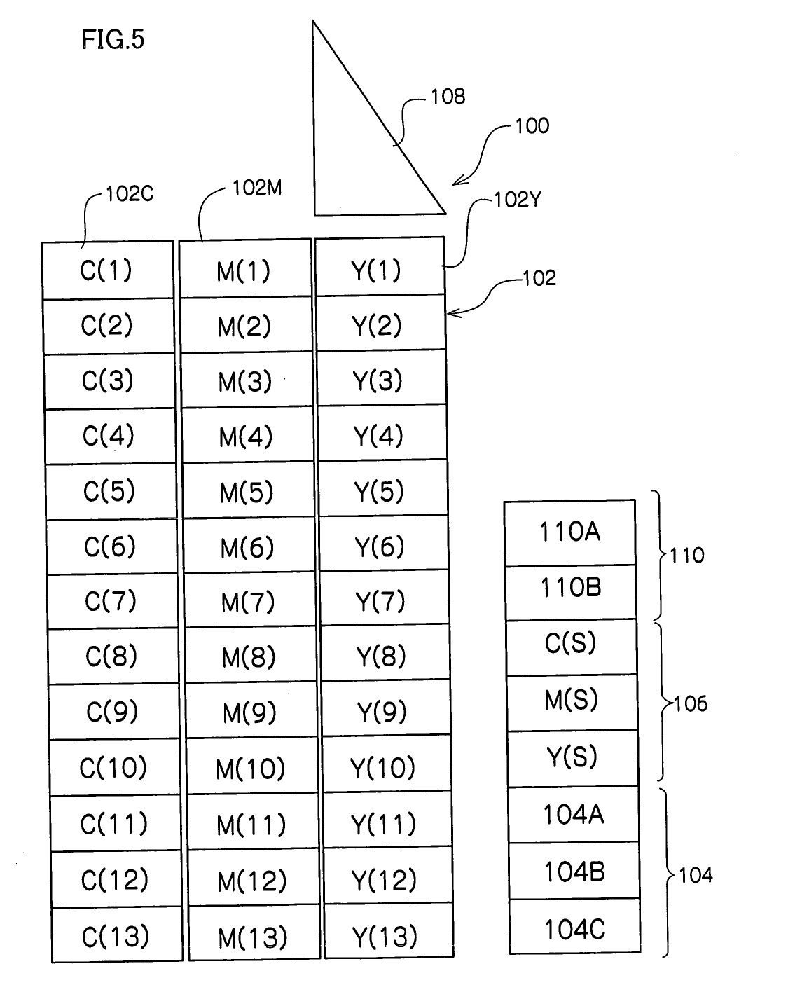

The patch sheet 100 shown in FIG. 5 is provided as an example in which the feed quantity correction patch 110 has been formed adjacent to the upward part of the color correction patch 106 as shown in FIG. 3. The feed quantity correction patch 110 is as described in the section describing the patch sheet shown in FIG. 4.

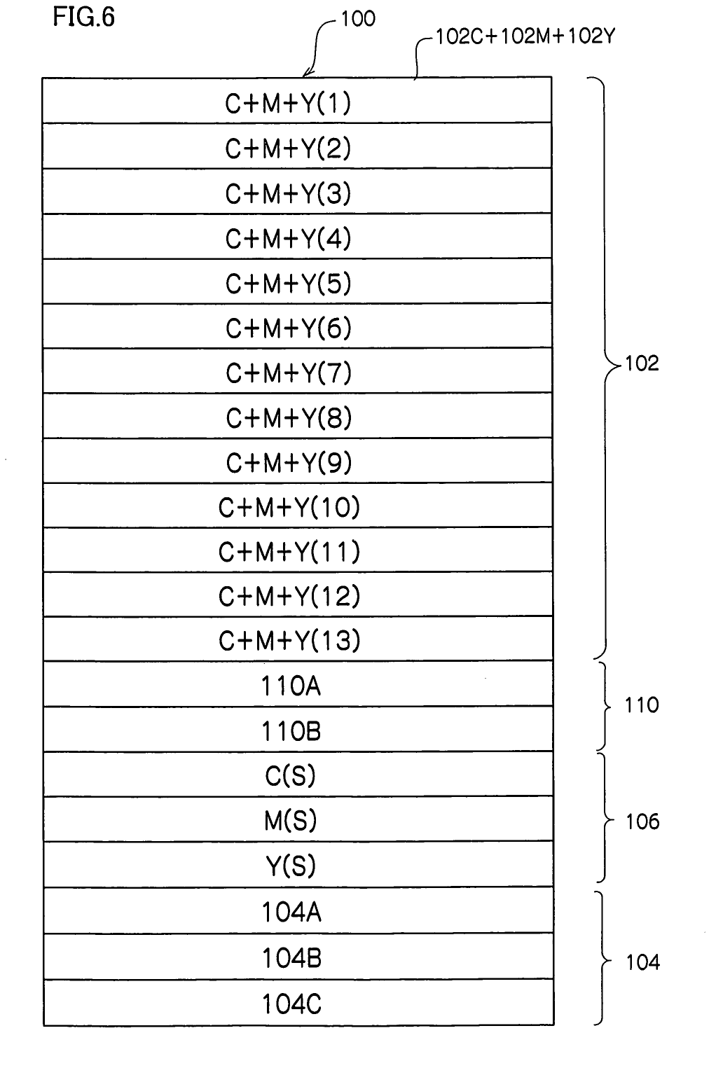

The patch sheet 100 shown in FIG. 6 is provided as an example in which the density region columns 102C, 102M, and 102Y are formed to be superimposed in the correction test pattern 102, and the feed quantity correction patch 110, color correction patch 106, and output medium information patch 104 are contiguously formed beneath the correction test pattern 102.

In FIG. 6, each of the regions of the correction test pattern 102 are indicated by C+M+Y(1) to C+M+Y(13), respectively. A region of C+M+Y(n) denotes that a C(n) region, an M(n) region, and a Y(n) region of the correction test pattern 102 in the patch sheet 100 shown in FIGS. 3 to 5 are formed to be superimposed. The lowercase letter “n” used here denotes an integer of any of numbers 1 to 13. Unlike the patch sheet 100 of FIGS. 3 to 5, the patch sheet 100 of FIG. 6 is featured in that all of the correction test pattern 102, feed quantity correction patch 110, color correction patch 106, and output medium information patch 104 can be read by merely passing the patch sheet reading portion 22 once. In FIG. 6, although the color correction patch is composed of three regions C(S), M(S), and Y(S), it may be made of one region in which the region C(S), region M(S), and region Y(S) are formed to be superimposed.

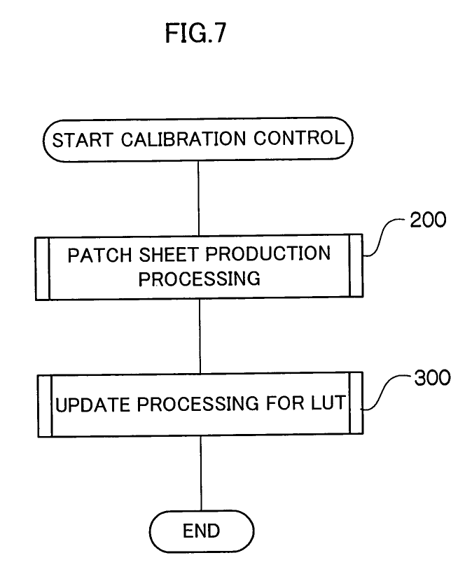

Hereinafter, procedures for reading the patch sheet 100 by the patch sheet reading portion 22, and calibrating the exposure portion 18 based on a result of the reading will be described with reference to FIGS. 7 to 9.

When the patch sheet 100 is set at the patch sheet reading portion 22, the patch sheet reading portion 22 reads the calibration test pattern 102 formed on the patch sheet 100. Then, this reading portion automatically measures a density of each of the colors, cyan, magenta, and yellow in each of the regions. In addition, the patch sheet reading portion 22 further measures a density of the output medium information patch 104 formed and recorded in the patch sheet 100. In a case where the patch sheet 100 has the color correction patch 106, as shown in FIGS. 3, 5, or 6, this reading portion measures a density of each of the colors, cyan, magenta, and yellow with respect to each of the regions of the color correction patch 106, and corrects a measurement result of the density in the output medium information patch 104 based on the measurement result of the density. In addition, in a case where the above patch sheet has a feed quantity correction patch 110, as shown in FIGS. 4, 5, or 6, the patch sheet corrects a patch sheet feed quantity of the correction test pattern 102 and the output medium information patch 104 at the patch sheet reading portion 22 based on data on the feed quantity obtained by reading the feed quantity correction patch 110. Then, based on the corrected measurement results of the density and feed quantity, the patch sheet reads output medium information such as a magazine ID or printing paper type recorded as color information in the output medium information patch 104; and a temperature and output date and time recorded separately as output condition information. The density of the correction test pattern 102 read by the patch sheet reading portion 22; and a result of reading of the magazine ID, printing paper type, temperature, and output date and time are stored in the RAM 74B.

The CPU 72 selects a lookup table corresponding to the read magazine ID and printing paper type from among the lookup tables stored in the storage means 76. Further, this CPU corrects and updates the thus selected lookup table based on the measurement result of the density by the patch sheet reading portion 22 and the correction test pattern data stored in the ROM 74A.

In addition, the CPU 72 compares a temperature recorded in the patch sheet 100 with a current temperature measured by the temperature sensor 82. In a case where a temperature difference is equal to or greater than a predetermined value, the CPU causes the display 16M of the image processing portion 16 to display an error message.

Moreover, the CPU 72 checks whether or not the magazine is the latest from the output date and time recorded in the patch sheet 100 and the output history information stored in the storage means 76. In a case where the magazine is not the latest, this CPU causes the display 16M of the image processing portion 16 to display an error message.

Now, calibration procedures for the exposure portion 18 will be described here. Calibration of the exposure portion 18 may be executed by an operator's instruction when, for example, the magazine 64 (or 65) has been replaced with the replacement magazine. In addition, such calibration may be executed at a predetermined time, for example, at the start time of the business day.

The calibration procedures for the exposure portion 18 is shown in FIG. 7. In calibration of the exposure portion 18, as shown in FIG. 7, first, patch sheet production processing for producing the patch sheet 100 based on the stored lookup table is carried out in step 200. Next, in step 300, lookup table update processing 300 for updating the lookup table based on the patch sheet 100 is carried out. Now, a detailed description will be given with respect to step 200 and step 300.

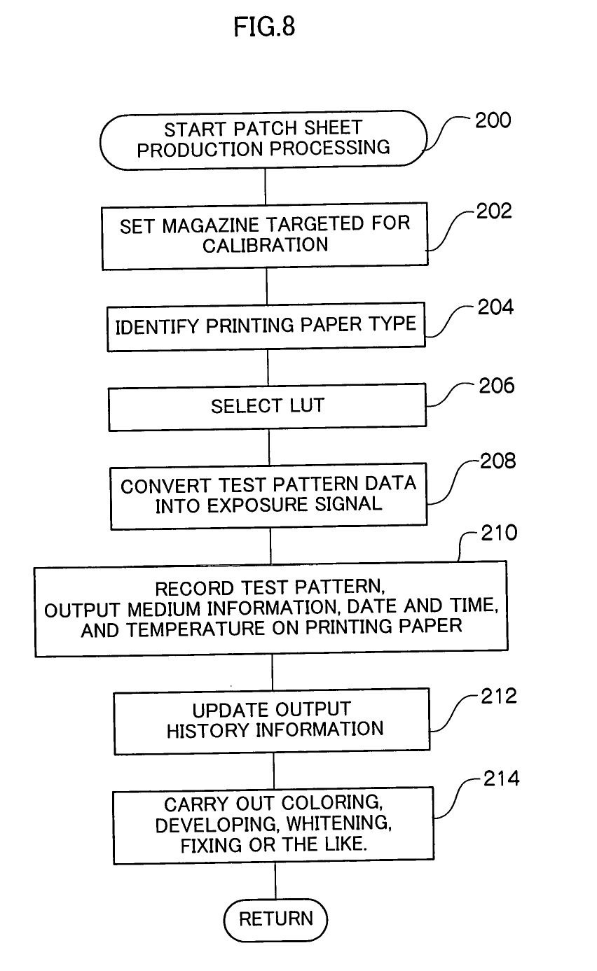

In step 200, as shown in FIG. 8, a magazine targeted for calibration is set in step 202. Specifically, ID of the magazine 64 (or 65) set at the laser printer portion 18 is sensed by the identification sensors 67 and 68. When the patch sheet 100 is produced, printing paper mounted on any of the magazines 64 and 65 is set. The above setting is specifically provided by specifying the magazine ID. Now, a description will be given with respect to a case in which calibration has been instructed for a magazine whose magazine ID is 1 (that is, magazine 64).

After the magazine has been set in step 202, the type of the printing paper set at the magazine targeted for calibration is identified in step 204. Here, the magazine ID of the magazine targeted for calibration in step 202 has been set to 1, and therefore, the printing paper type of printing paper 62 set at the magazine 64 is identified by the identification sensor 67.

In step 206, a lookup table corresponding to the magazine ID set in step 202 and the printing paper type identified in step 204 are selected from the storage means 76. That is, a lookup table corresponding to the printing paper 62 set at the magazine 64 is selected.

In a case where the corresponding lookup table is not stored in the storage means 76, a default value lookup table is stored in advance in the storage means 76 so that the default value lookup table may be selected. In addition, by providing priority to the magazine ID and printing paper type, in a case where the corresponding lookup table is not stored in the storage means 76, a lookup table coinciding with higher priority may be selected.

When a lookup table has been selected in step 206, image data on the calibration test pattern 102 stored in the ROM 74A is converted into an exposure signal based on the lookup table in step 208.

In step 210, the LD 52 is driven in accordance with this exposure signal, exposure is carried out by emitting a laser light beam to the printing paper 62, and a latent image of the calibration test pattern 102 is formed.

At the same time, based on the output medium information indicating the printing paper type identified in step 204, a laser light beam is emitted to a region adjacent to the calibration test pattern 102 to form the output information patch 104 which consists of the regions 104A to 104C indicating the output medium information. Then, based on the output condition information such as temperature and date and time during output of the calibration test pattern 102 measured by the temperature sensor 82, a latent image of the output condition information 105 is formed in a region other than the region in which the calibration test pattern 102 and output medium information patch 104 have been formed.

Further, laser light beams of three colors of R, G, and B are emitted at a predetermined density so as not to be superimposed on one another, and the color correction patch 106 is formed. When the patch sheet 100 shown in FIG. 6 is produced, laser light beams of three colors of R, G, and B are emitted to the same region at the same time at a predetermined strength, and the color correction patch 106 is formed.

After the latent image of the patch sheet 100 has been formed in step 210, processing goes to step 212 in which the output history information contained in the storage means 76 is updated and recorded at a date and time during calibration pattern output of step 210. In this manner, the output history information is updated to information obtained during the latest calibration pattern output.

In step 214, the printing paper 62 on which the latent image of the patch sheet 100 has been formed is processed to be colored and developed at the developing portion 20. Then, processings such as whitening and fixing, washing with water, and drying are applied, and the patch sheet 100 as shown in FIGS. 3 to 6 is produced.

When the patch sheet 100 is produced, lookup table update processing is carried out as shown in step 300 in FIG. 7.

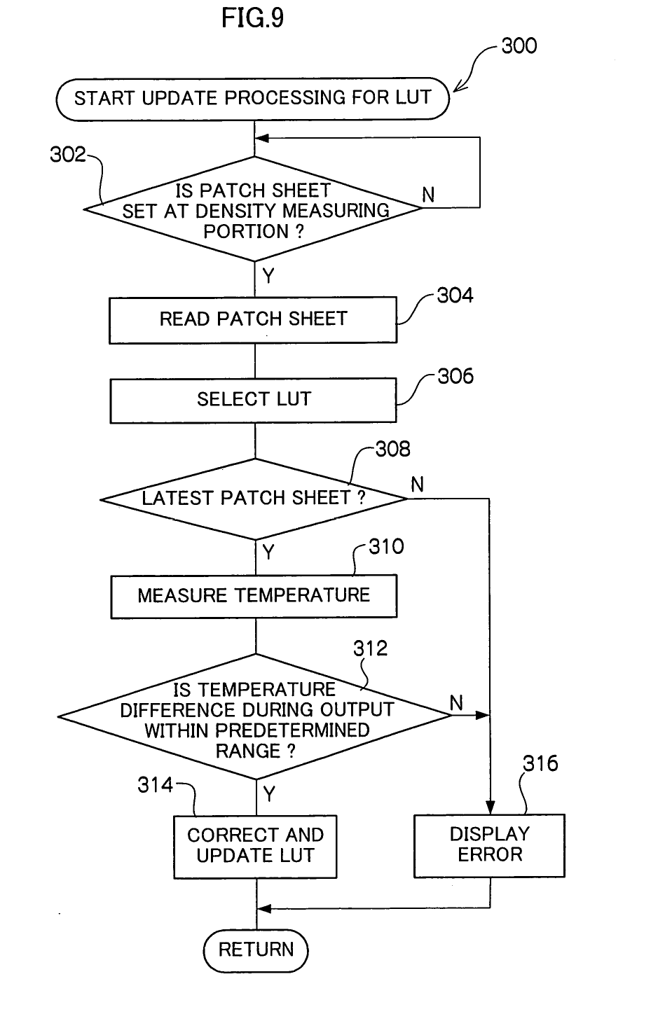

In lookup table update processing, as shown in FIG. 9, first, it is determined whether or not the patch sheet 100 has been inserted into the patch sheet reading portion 22 in step 302.

In step 302, when it is verified that the patch sheet 100 has been inserted into the patch sheet reading portion 22, the densities of the correction test pattern 102, the output medium information patch 104, and the color correction patch 106 in the patch sheet 100 are measured by means of the patch sheet reading portion 22 in step 304, whereby the color density in each region of the correction test pattern 102, the output medium information, and the output condition information are read and stored in the RAM 74B.

In step 306, the lookup table corresponding to the output medium information read in step 304 is selected from among the lookup tables stored in the storage means 76.

In step 308, it is checked whether or not the date and time during calibration test pattern output read in step 304 matches with the output history information stored in the storage means 76 and corresponding to the magazine ID targeted for calibration. In a case where both of them correspond with each other, it is judged that the patch sheet 100 inserted into the patch sheet reading portion 22 in step 302 is a correct patch sheet, and processing goes to step 310.

In step 310, a temperature during reading in the patch sheet reading portion 22 is measured by the temperature sensor 82. Next, in step 312, a measurement value of a temperature when the patch sheet 100 is being read is compared with a temperature during calibration test pattern output read in step 304, and it is checked whether or not the temperature difference is within a predetermined range. In a case where the temperature difference is within the predetermined range, it is judged that a change of exposure quantity—coloring density characteristics due to a temperature change is within a negligible range, and processing goes to step 314.

In step 314, the lookup table of the magazine ID targeted for calibration, the table being stored in the storage means 76, is corrected based on: the density of each of the regions C(1) to C(13), M(1) to M(13), and Y(1) to Y(13) of the calibration test pattern 102 read in step 304; and the data on the calibration test pattern stored in the ROM 74A. In addition, this lookup table is updated and stored as a lookup table of the magazine ID targeted for calibration.

At this time, printing paper characteristic data (sensitivity change characteristics caused by environmental conditions such as temperature and humidity, sensitivity change characteristics arising from the degree of degradation of a developer, and the like) are stored in advance in the storage means 76 by each printing paper type; and the corresponding printing paper characteristic data is selected from the read output medium information so as to be used for computation for lookup table correction.

On the other hand, in step 308, in a case where it is determined that the date and time during calibration test pattern output read in step 304 does not match with the output history information corresponding to the magazine ID targeted for calibration, the information being stored in the storage means 76, processing goes to step 316 in which an error message is displayed on the display 16M provided at the image processing portion 16, and calibration is canceled. In this manner, a user can be notified that the patch sheet 100 produced on the printing paper set at a magazine other than that targeted for calibration, or the patch sheet 100 which is not the latest, has been mistakenly selected and inserted into the patch sheet reading portion 22. Thus, improper calibration can be prevented from being carried out.

In step 312, in a case where it is determined that a difference between a measurement value of a temperature when the patch sheet 100 is being read and a temperature during calibration test pattern output read in step 304 is out of a predetermined range as well, processing goes to step 316 in which an error message is displayed on the display 16M provided at the image processing portion 16, and calibration is canceled. In this manner, it can be notified to a user that the temperature varies greatly from that during production of the patch sheet 100, and inaccurate calibration including a deviation of exposure quantity—coloring density characteristics due to a change in temperature can be prevented from being carried out.

As described above, in the present embodiment, output medium information concerning a magazine ID for identifying a magazine or printing paper type is recorded in a patch sheet together with a calibration test pattern; the output medium information is read from the patch sheet during density measurement using the patch sheet reading portion 22; the corresponding lookup table is selected; and calibration is carried out. In this manner, an accident in which a lookup table containing a magazine or printing paper type different from that targeted for calibration is retrieved and updated can be prevented.

Further, the date and time during production of the patch sheet 100 is recorded in the patch sheet 100 together with the calibration test pattern 102; the date and time during this recording is read from the patch sheet 100 during density measurement using the patch sheet reading portion 22; and the read date and time is checked with output history information contained in the patch sheet stored in the apparatus. In this manner, calibration using an old patch sheet can be prevented from being carried out.

Additionally, a temperature during production of the patch sheet 100 is recorded in the patch sheet together with the calibration test pattern; the temperature is read from the patch sheet 100 during reading of the patch sheet 100 using the patch sheet reading portion 22; and the read temperature is compared with the temperature during the reading. In this manner, in a case where a temperature varies greatly from that obtained during production of the patch sheet 100, calibration including a deviance of exposure quantity—coloring temperature characteristics due to a change in temperature can be prevented from being carried out.

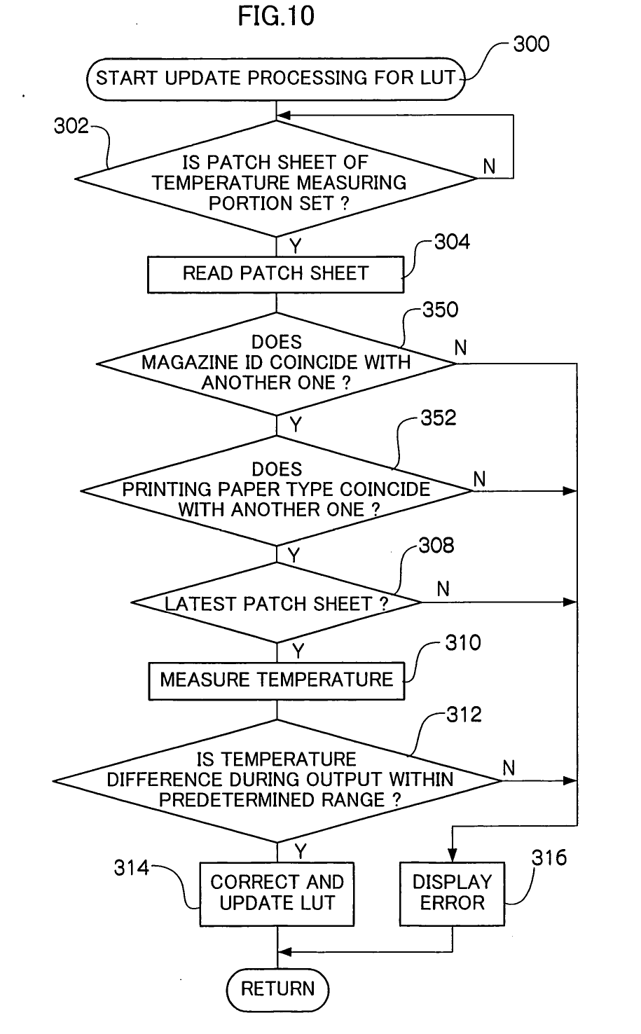

In the present embodiment, although calibration is carried out by selecting the lookup table based on the output medium information recorded in the patch sheet 100, the invention is not limited to this calibration. For example, the output medium information recorded in the patch sheet 100 and the output medium information targeted for calibration are checked with each other, whereby it may be judged whether or not the patch sheet 100 is a proper patch sheet 100. FIG. 10 shows an example of lookup table update processing in this case. In FIG. 10, like processings in FIG. 9 are designated by like reference numerals. A duplicate description is omitted here.

In FIG. 10, processings of steps 350 and 352 are carried out instead of the lookup table selection processing of step 306 in FIG. 9.

That is, in step 304, when the density of each patch 102 of the calibration test pattern recorded in the patch sheet 100; output medium information (magazine ID and printing paper type); and output condition information (temperature and date and time during calibration test pattern output) are read, processing goes to step 350.

In step 350, it is checked whether or not the magazine ID read in step 304 corresponds with the magazine ID targeted for calibration. In a case where the above magazine IDs correspond with each other, processing goes to step 352.

In step 352, it is checked whether or not the printing paper type read in step 304 matches with the printing paper type corresponding to the magazine ID targeted for calibration, the printing paper type being stored in the storage means 76. In a case where the printing paper types correspond with each other, processing goes to step 308 in which it is checked whether or not the patch sheet 100 is the latest patch sheet.

On the other hand, in a case where the magazine IDs do not correspond with each other in step 350 or in a case where the printing paper types do not correspond with each other in step 352, processing goes to step 316 in which an error message is displayed on the display 16M provided at the image processing portion 16, and calibration is canceled.

In this manner, the output medium information recorded in the patch sheet 100 and the output medium information targeted for calibration are checked with each other, whereby improper calibration can be prevented from being carried out as a result of mistakenly using the patch sheet 100 produced on the printing paper set at a magazine other than that targeted for calibration. In addition, after production of the patch sheet 100, in a case where the printing paper set at the magazine targeted for calibration has been replaced with a replacement printing paper, improper calibration can be prevented from being carried out.

As described previously, in the patch sheet 100, the output medium information contained in the output information patch 104 is indicated by the three regions 104A, 104B, and 104C using anyone of white, black, cyan, magenta, yellow, and a mixed color of magenta and yellow. Therefore, with respect to the combination of the regions 104A, 104B and 104C, there are 125 combinations expressed by 5³ even if combinations of five colors exist, and therefore a total of 125 combinations of the output medium information can be displayed. Accordingly, in the output medium information patch 104, much more output medium information can be displayed in a fewer number of regions.

Moreover, in the output medium information patch 104, it is also possible to display output medium information and output condition information without using yellow. In this case, black, white, cyan, magenta, and a mixed color of cyan and magenta are used to display the output medium information. As a result, as in a case where a degraded developer is used at the developing portion 20, the output medium information patch 104 is hardly misread also in a case where the patch sheet 100 has been produced by developing printing paper under a condition in which a Y stain likely occurs.

Further, as shown in FIGS. 3, 5, and 6, by adding the color correction patch 106 to the patch sheet 100, a reading result of the output medium information patch 104 can be corrected based on the reading result in the color correction patch 106. Thus, the possibility of misreading the output medium information patch 104 is further reduced.

As shown in FIGS. 4, 5, and 6, when the feed quantity correction patch 110 is added to the patch sheet 100, a relationship between a true feed quantity and a measurement result of a feed quantity at the patch sheet reading portion 22 can be obtained by reading the feed quantity correction patch 110. Based on this result, an error of a feed quantity of the patch sheet 100 can be corrected. Therefore, misreading due to accumulation of the errors of the feed quantities can be eliminated.

Since improvement in precision of a feed quantity can be expected, the length in the feed quantity of each patch can be reduced, and the length in the transfer direction of the entire patch sheet can be reduced.

Furthermore, as shown in FIG. 6, in the patch sheet 100, the density region columns 102C, 102M, and 102Y are formed to be superimposed, thereby making it possible to read out all the density region columns by one feed in the patch sheet reading portion 22. Thus, a configuration of the patch sheet reading portion 22 is simplified, and accumulation of the feed errors due to repeated feeding of the patch sheet can be prevented at the patch sheet reading portion 22.

As can be seen above, according to the invention, there is provided a sheet for color calibration in which much output medium information can be contained, and virtually no misreading of output medium information occurs; a color calibrating method using the sheet for color calibration; and an image recording apparatus for producing the sheet for color calibration to carry out color correction.

What is claimed is:

1. A sheet for color calibration, comprising:
(a) an output medium information patch which displays output medium information;
(b) a test pattern for color calibration; and
(c) at least one of a first reference patch which displays color information serving as a reference for color correction when the output medium information patch is read, and a second reference patch serving as a reference for correcting a feed length when the sheet for color calibration is read.

2. The sheet for color calibration according to claim 1, wherein the output medium information patch and the test pattern for color calibration are formed by exposing a photosensitive material with a predetermined amount of light exposure.

3. The sheet for color calibration according to claim 1, wherein the first reference patch and the second reference patch are formed by exposing a photosensitive material with a predetermined amount of light exposure.

4. The sheet for color calibration according to claim 1, wherein the first reference patch and the second reference patch are arranged substantially in a single column.

5. The sheet for color calibration according to claim 1, wherein the test pattern is formed on a color-by-color basis of cyan, magenta, and yellow, and includes a plurality of density regions arranged column-wise in order of color brightness or in order of color darkness along a reading direction of the calibration sheet.

6. The sheet for color calibration according to claim 1, wherein the test pattern has a mixed color of cyan, magenta, and yellow, and includes a plurality of density regions arranged column-wise in order of color brightness or in order of color darkness along a reading direction of the calibration sheet.

7. The sheet for color calibration according to claim 6, wherein the test pattern and the output medium information patch are arranged substantially in a single column.

8. The sheet for color calibration according to claim 6, wherein the test pattern, the output medium information patch, the first reference patch, and the second reference patch are arranged substantially in a single column.

9. The sheet for color calibration according to claim 1, wherein the output medium information patch includes a combination of patches having any one of white, black, cyan, magenta, and a mixed color of cyan and magenta.

10. A color calibrating method when an image is recorded on a sheet for color calibration which includes:
an output medium information patch which displays output medium information;
a test pattern for color calibration; and
at least one of a first reference patch which displays color information serving as a reference for color correction when the output medium information patch is read, and a second reference patch serving as a reference for correcting a feed length when the sheet for color calibration is read, the method comprising:
feeding in one direction or reading in a reciprocate manner the sheet for color calibration along a direction of forming the test pattern and the output medium information patch; and
calibrating a color of an image based on the read test pattern information and output medium information.

11. An image recording apparatus comprising:
(A) a color calibration sheet forming portion which forms a sheet for color calibration including an output medium information patch which displays output medium information, a test pattern for color calibration, and at least one of a first reference patch which displays color information serving as a reference for color correction when the output medium information patch is read, and a second reference patch serving as a reference for correcting a feed length when the sheet for color calibration is read;
(B) a reading portion which reads the sheet for color calibration; and
(C) a calibration control portion which carries out calibration of a color of an image according to the reading result.

12. Then image recording apparatus according to claim 11, wherein the calibration control portion comprises:
a storage portion which stores reference output information in advance;
a checking portion which checks the reference output medium information with output medium information obtained by reading of the sheet for color calibration; and
a selecting portion which selects a test pattern for color calibration to be used for calibration from among test patterns for color calibration obtained by the reading according to the checked result.
